(19) United States
(12) Patent Application Publication
(10) Pub. No.: US 2010/0108613 A1
(43) Pub. Date: May 6, 2010

(54) Methods and Compositions to Remove Coal Fines From Aqueous Fluids

(75) Inventors: James B. Crews, Willis, TX (US); Tianping Huang, Spring, TX (US)

Correspondence Address: Mossman, Kumar and Tyler, PC, P.O. Box 421239, Houston, TX, 77242, US

(73) Assignee: Baker Hughes Incorporated, Houston, TX (US)

(21) Appl. No.: 12/643,274

(22) Filed: Dec. 21, 2009

Related U.S. Application Data
(63) Continuation-in-part of application No. 12/546,763, filed on Aug. 25, 2009.
Application No. 12/546,763 is a continuation-in-part of application No. 11/931,501, filed on Oct. 31, 2007.
Application No. 11/931,501 is a continuation-in-part of application No. 12/277,825, filed on Nov. 25, 2008.
Application No. 12/277,825 is a continuation-in-part of application No. 11/931,706, filed on Oct. 31, 2007.

(51) Int. Cl. C02F 1/28; B05D 7/00

(52) U.S. Cl. 210/691; 210/282; 427/180; 977/773; 977/902

(57) ABSTRACT

Nanoparticle-treated particle packs, such as sand beds, may effectively remove coal fines from aqueous fluids, such as contaminated water. A porous substrate treated with nanoparticles, such as alkaline earth metal oxides/hydroxides, transition metal oxides/hydroxides, post-transition metal oxides/hydroxides, piezoelectric crystals, and/or pyroelectric crystals, may remove a substantial portion of coal fines from an aqueous fluid. It is believed that the nanoparticles capture and hold the coal fines in the particle pack due to surface forces, including van der Waals and/or electrostatic forces. The nanoparticles may be applied to the substrate via a coating agent, such as alcohol, glycol, polyol, olefin, vegetable oil, fish oil, and/or mineral oil.

### CROSS-REFERENCE TO RELATED APPLICATIONS

This application is a continuation-in-part patent application of U.S. Ser. No. 12/546,763, filed Aug. 25, 2009, which in turn is a continuation-in-part patent application of U.S. Ser. No. 11/931,501, filed Oct. 31, 2007, and Ser. No. 12/277,825, filed Nov. 25, 2008, which in turn is a continuation-in-part patent application of U.S. Ser. No. 11/931,706, also filed Oct. 31, 2007.

### TECHNICAL FIELD

The present disclosure relates to methods and compositions for removing coal fines from aqueous fluids, and more particularly, in one non-limiting embodiment, relates to methods and compositions for removing coal fines from water using particle packs that have been treated with nanoparticles.

### BACKGROUND

Fluids utilized in coal mining and coal bed methane extraction, including water, air, and other fluids, may pick up small particulates known as coal fines and carry these particulates out of a coal bed. Additionally, anywhere that coal and aqueous fluids are mixed, such as in transportation or at a coal plant, the fluids may pick up coal fines. Coal fines are particulates generally having an average particle size of less than 50 microns (μm). The fluids picking up these coal fines may include methane for production or water for disposal or recycling. However, the particulate coal fines may make a fluid unsuitable for disposal, use, or additional processing. That is, the particulate coal fines may be considered a pollutant in wastewater or may clog pipes and valves in a production plant. Accordingly, it may be desirable to remove the coal fines from aqueous fluids prior to disposal, production, or recycling.

Many methods and processes are known to clean, purify, clarify and otherwise treat fluids for proper disposal, use, and other needs. These methods include, but are not limited to, centrifugation and filtration to remove particulates, chemical treatments to sterilize water, distillation to purify liquids, decanting to separate two phases of fluids, reverse osmosis and electrodialysis to desalinate liquids, pasteurization to sterilize foodstuffs, and catalytic processes to covert undesirable reactants into useful products. Each of these methods is well-suited for particular applications, and a combination of methods is typically used for a final product.

In removing coal fines from aqueous fluids, current methods and processes may not result in adequate removal of the particulates for the desired purposes. There is always a need to develop new apparatus and methods to more efficiently and cost-effectively remove particulate matter from aqueous fluids, particularly where the fluids may then be recycled, reused, or further produced.

### SUMMARY

There is provided, in one non-limiting form, a method for removing coal fines from fluids. The method may include, for example, contacting an aqueous liquid that contains coal fines with a particle pack that contains substrate particles and nanoparticle additives. The nanoparticle additives may be alkaline earth metal oxides, alkaline earth metal hydroxides, transition metal oxides, transition metal hydroxides, post-transition metal oxides, post-transition metal hydroxides, piezoelectric crystals, and/or pyroelectric crystals.

There is further provided, in another non-limiting embodiment, a particle pack for removing coal fines from an aqueous fluid. The particle pack may include substrate particles and nanoparticle additives. In an exemplary embodiment, the substrate particles may include sand, gravel, ceramic beads, and/or glass beads. In addition, the nanoparticle additives may be alkaline earth metal oxides, alkaline earth metal hydroxides, transition metal oxides, transition metal hydroxides, post-transition metal oxides, post-transition metal hydroxides, piezoelectric crystals, and/or pyroelectric crystals, and they may be present in the particle pack in an amount effective to remove at least a portion of the coal fines from the aqueous fluid.

Furthermore, in another non-limiting embodiment, there may be provided a method for preparing a particle pack for removal of coal fines from an aqueous fluid. This method may include, for example, adding a nanoparticle additive to a carrier fluid to create a nano-fluid, coating porous substrate particles with the nano-fluid, and forming the substrate particles into a particle pack.

### BRIEF DESCRIPTION OF THE DRAWINGS

FIG. 1 is a photograph of tap water containing no coal fines flowing through a sand pack containing no nanoparticles;

FIG. 2 is a photograph of tap water containing coal fines flowing through a sand pack containing no nanoparticles;

FIG. 3 is a photograph of tap water containing coal fines flowing through a sand pack containing nanoparticles; and

FIG. 4 is a photograph of laboratory beakers holding effluents collected via the configurations of FIGS. 2 and 3, respectively.

### DETAILED DESCRIPTION

In accordance with a present embodiment, a nanoparticle-treated porous medium may be used to remove coal fines from aqueous fluids. For example, magnesium oxide (MgO) having an average particle size of about 30 nm may be coated onto a substrate such as coarse sand or ceramic particles. As used in the present disclosure, a nanoparticle is a particle or crystal having a diameter of less than 1000 nm, and may alternatively be referred to as a nano-sized particle. In addition, it should be appreciated that, although MgO nanoparticles are referred to throughout the present disclosure, other nanoparticles or nanocrystals may be used in the methods and compositions herein. When an aqueous fluid containing particulate coal fines moves through a nano-particle-treated porous medium, the nanoparticles may capture and hold the coal fines via surface and other forces, such as, for example, van der Waals and electrostatic forces. This unique and simple process removes coal fines from the fluid very efficiently, thereby enabling recycling, reuse, continued production, or other uses of the fluid.

Nanoparticles like MgO inherently have high surface areas due to their small sizes. In addition, the nanoparticles or nanocrystals may have high surface charges, enabling them to associate, link, or connect other particles together. The coal fines may or may not have surface charges, depending on the grade of coal, impurities present within or mineralized within the coal, how the fines were generated, and the like. For example, lower grade coals often have charge-related impurities. As used in the present disclosure, coal fines include particulates having an average particle size of less than about 50 μm, or, alternatively, less than about 37 μm. The nanoparticles may remove, reduce, or rid the coal fines from a fluid, such as water or brine, flowing through the porous substrate. In an exemplary embodiment, the coal fines may associate or connect with the nanoparticles due to electrical attractions and other intermolecular forces or effects.

As will be shown, laboratory tests have demonstrated that relatively small amounts of nanoparticles or nanocrystals may remove and eliminate coal fines suspended in aqueous fluids, such as water. A nanoparticle-treated particle pack or bed may be generated by applying the nanoparticles directly to a porous medium, for example, by contacting the substrate with a fluid in which the nanoparticles are suspended. Exemplary porous media suitable as substrate particles in the pack or bed may include, but are not limited to, sand (e.g., silica, quartz, feldspars, and the like), gravel, ceramic, glass, and similar particles or crystals, or combinations thereof. In one embodiment, a mixture of a coating agent and nanoparticle additives at least partially coats the substrate particles. If the porous substrate is at least partially coated with the coating agent and the nanoparticles, then the contaminants and impurities (e.g., coal fines) may be removed from the fluid (e.g., water) and may be eliminated or suppressed, thereby purifying the fluid.

Exemplary nanoparticles suitable for use in the present methods and compositions may include, but are not limited to, alkaline earth metal oxides, alkaline earth metal hydroxides, transition metal oxides, transition metal hydroxides, post-transition metal oxides, post-transition metal hydroxides, piezoelectric crystals, pyroelectric crystals, or a combination thereof. Such nano-sized particles have been discovered to have particular advantages for capturing coal fines and removing them from aqueous fluids.

As used herein, “alkaline earth metals” are those metals of Group 2, including, but not necessarily limited to, magnesium (Mg), calcium (Ca), strontium (Sr), and barium (Ba). “Transition metals” are those metals of Groups 3-12, including, but not necessarily limited to, titanium (Ti), zirconium (Zr), cobalt (Co), nickel (Ni), and zinc (Zn). “Post-transition metals” are those metals of Groups 13-15, including, but not necessarily limited to, aluminum (Al), gallium (Ga), indium (In), tin (Sn), thallium (TI), lead (Pb), and bismuth (Bi). In another non-limiting embodiment, there is an absence of alumina (aluminum oxide) and/or aluminum hydroxide from the suitable nanoparticles.

Some metal oxides/dioxides particularly suitable in the present methods and compositions may include, for example, magnesium oxide (MgO), zinc oxide (ZnO), aluminum oxide (Al₂O₃), zirconium dioxide (ZrO₂), titanium dioxide (TiO₂), cobalt (II) oxide (CoO), and nickel (II) oxide (NiO). In one exemplary embodiment, MgO having a purity of at least 95 wt % may be utilized. The balance of such an additive mixture may include, for example, magnesium hydroxide (Mg(OH)₂), calcium oxide (CaO), calcium hydroxide (Ca(OH)₂), silicon dioxide (SiO₂), aluminum oxide (Al₂O₃), and so forth.

The nano-sized particles described herein may also be piezoelectric crystal particles (which include pyroelectric crystal particles). Piezoelectric crystals generate electrical charges when squeezed, compressed, or pressed, and pyroelectric crystals generate electrical charges when heated. In one non-limiting embodiment, suitable piezoelectric crystal nanoparticles may include, but are not necessarily limited to, zinc oxide (ZnO), berlinite (AlPO₄), lithium tantalate (LiTaO₃), gallium orthophosphate (GaPO₄), barium titanate (BaTiO₃), strontium titanate (SrTiO₃), lead zirconate titanate (Pb(Zr, Ti)O₃), potassium niobate (KNbO₃), lithium niobate (LiNbO₃), lithium tantalate (LiTaO₃), bismuth ferrite (BiFeO₃), sodium tungstate (Na₂WO₄), Ba₂NaNb₅O₅, Pb₂KNb₅O₁₅, potassium sodium tartrate, tourmaline, topaz, and mixtures thereof. The total pyroelectric coefficient of ZnO is about −9.4 C/m²K. Zinc oxide and these other crystals are generally not water soluble.

In an exemplary embodiment using pyroelectric nanocrystals in the particle pack, the pyroelectric crystals may be heated and/or pressurized to generate high surface charges. These surface charges enable the nanocrystals to associate, link, connect, or otherwise relate the coal fine particulates together to hold or bind them to one another and/or to the surrounding particle pack surfaces.

The removal of coal fines according to the method herein may result in the accumulation of several layers of coal fines upon the nanoparticle-coated particles comprising the porous media pack; that is, the nanoparticle-coated media can attract and hold a surprisingly large amount of coal fines of significant thickness before becoming saturated.

The size of nanoparticles described herein may range, for example, from about 4 nm to about 1000 nm; from about 4 nm to about 500 nm; from about 1 nm to about 500 nm; or from about 4 nm to about 100 nm. In additional exemplary embodiments, the nanoparticles or nanocrystals may have a mean particle size of about 250 nm or less; about 100 nm or less; about 90 nm or less; about 50 nm or less; or about 40 nm or less. Furthermore, the amount of nanoparticles coated onto the porous substrate may be from about 1 pound of nanoparticles per about 200 to about 5000 pounds of particle pack. It should be appreciated that any other unit of weight may be used, such as, for example, about 1 gram of nanoparticles per about 200 to about 5000 grams of particle pack. In another embodiment, the nanoparticles may be present in an amount from about 1 part by weight of nanoparticles to about 1000 to about 2000 parts by weight of particle pack.

In an exemplary embodiment, the nano-sized particles may be added in a dry, powder form to mix directly with the dry substrate particles. In another non-limiting embodiment, as noted above, the nanoparticles may be applied to the porous substrate via a carrier fluid, such as a coating agent. The coating agent may be a fluid that includes, but is not necessarily limited to, fresh water, brine water, alcohol, glycol, polyol, alkyl carbonate, olefin, organic solvents, vegetable oil, fish oil, mineral oil, another hydrocarbon that accomplishes the purposes of the methods and compositions described herein, or combinations thereof. Non-limiting examples of brine water include, but are not necessarily limited to, produced water, seawater, sodium chloride (NaCl) brine, potassium chloride (KCl) brine, calcium chloride (CaCl₂) brine, and the like. Non-limiting examples of alcohols include methanol, ethanol, propanol, and the like. Non-limiting examples of glycols includes ethylene glycol, diethylene glycol, polyethylene glycol, propylene glycol, dipropylene glycol, polypropylene glycol, and the like. Non-limiting examples of polyols include solutions of sorbitol, mannitol, fructose, glucose, galactose, lactose, sucrose, xylitol, maltitol, glycerol, and the like. Non-limiting examples of alkyl carbonates include propylene carbonate and ethylene carbonate. Non-limiting examples of organic solvents include xylene, toluene, acetone, methyl acetate, ethyl benzoate, limonene, and the like. Non-limiting examples of vegetable and/or fish oils include soybean oil, corn oil, canola oil, linseed oil, peanut oil, olive oil, sunflower oil, walnut oil, coconut oil, cottonseed oil, salmon oil, cod liver oil, menhaden oil, refined and/or blended fish oils, and the like. Specific exemplary fish oils include Salmon Oil 6:9 and Fish Oil 18:12TG from Bioriginal Food & Science Corporation. Another exemplary coating agent may be monopropylene glycol (MPG). Specific, non-limiting examples of suitable mineral oils include ConocoPhillips PURE PERFORMANCE® Base Oils II or III, such as 80N, 11N, 225N, 600N, ULTRA-S™ 3 and ULTRA-S™ 8; Penreco DRAKEOL® oils, such as DRAKEOL® 21, DRAKEOL® 35 and DRAKE-OL® 600; and ExxonMobil Chemical mineral oils, such as EXXSOL® D80 and ISOPAR® M oils. A fines filtering product may include nanoparticles in the coating agent oil, such as, for instance, about 15 wt % nano-sized MgO particles in the PURE PERFOR-MANCE® 600N or DRAKEOL® 600 mineral oils.

In another exemplary embodiment, the carrier fluid may include the coating agent and a base fluid, which may be aqueous-based, alcohol-based, or oil-based. An aqueous base fluid may include, for example, water, brine, aqueous-based foams, or water-alcohol mixtures. The coating agent may include an oil that is the same as or different from the base fluid, if the base fluid is oil-based. The above-described fines filtering product (i.e., the nanoparticles in the coating agent) may be added to an aqueous base fluid in a relatively small amount. For example, in one non-limiting embodiment, the fines filtering product may be in a concentration of about 5 to about 10 gptg (gallons per thousand gallons) of base fluid. In this embodiment, at least a portion of the nano-sized particles may be coated on the substrate particles with the coating agent.

It has been discovered that during mixing with the particles of the pack or bed, the nanoparticles in oil, glycol, solvents, or other carriers will plate out on or at least partially coat the substrate particles. No coating agent is required for the nanoparticles to plate out onto the substrate particles in an aqueous base fluid; however, a coating agent may be used to increase, speed up, or improve the plating out of the nanoparticles onto substrate particles in an aqueous base fluid. That is, because the base fluid is aqueous in this exemplary embodiment, the hydrophobic coating agent is repulsed by the water and coats the substrate particles. The amount of substrate particle coating that occurs is concentration dependent, based on both the amount of substrate particles (e.g., sand) and nanoparticles (e.g., MgO) used.

In a non-limiting example, the carrier fluid may additionally contain a surfactant, such as an oil-wetting surfactant like sorbitan monooleate (e.g., SPAN 80 from Uniqema), to improve and/or enhance the oil-wetting of the pack or bed substrate particles by the nanoparticles. In another exemplary embodiment, the presence of a surfactant may preferentially reduce the thickness of the DRAKEOL® 600 mineral oil layer on the sand pack particles. Reduced oil layer thickness may enhance nanoparticle exposure on the porous substrate particles. Use of lower viscosity mineral oils, such as DRAKEOL® 15, DRAKEOL® 18, or EXXSOL® D80, may also reduce oil layer thickness. Other agents may also, or alternatively, be employed to optimize the oil coating, wetting, or thickness on the sand pack or ceramic bed particles. Such agents may include, for example, sorbitan esters, ethoxylated sorbitan esters, fatty acid alcohols, ethoxylated fatty acid alcohols, ethoxylated alkyl-phenols, alkyl-dicarboxylics, sulfosuccinates, phospholipids, alkylamines, quaternary amines, alkyl-siloxanes, and the like. It is not necessary that a resin be used as a coating agent or binder, and in one non-limiting embodiment, no resin is used.

A portion of the substrate particles may be “pre-coated” with the fines filtering product. For instance, pre-coating may be performed at the manufacturing site of the dry substrate or elsewhere. In one nonrestrictive version, the fines filtering product may be sprayed onto the dry substrate before the substrate particles are placed in the pack or bed. In another exemplary embodiment, a portion or all of the substrate particles may be pre-coated with nanoparticles or nanocrystals at the manufacturing or assembly site and placed within bags or a filtering apparatus like cartridges, canisters, and the like.

It is theorized that the nanoparticles remain on the particles of the porous substrate primarily by electrostatic and other charges between the nanoparticle and particle surfaces; however, other attractions or coupling forces may exist to initially and over the long-term keep the nanoparticles coated on the pack substrate particles, and the present disclosure does not rely on any particular theory. The carrier agent may often only assist the initial coating process of the nanoparticles onto the substrate particles. However, other agents may be added to the carrier fluid to further enhance the initial and/or long-term nanoparticle attraction to the substrate. Additionally, the surface of the substrate particles, or a portion thereof, may be treated with agent that may improve the overall attraction of the nanoparticles to the substrate.

The sand, ceramic, glass, or other substrate particles of the pack or bed may have a mean particle size, for example, from about 10 mesh (2000 μm) to about 325 mesh (45 μm) or from about 20 mesh (850 μm) to about 200 mesh (75 μm). Additionally, the substrate particle size range may be wide, such as from about 40 mesh (425 μm) to about 200 mesh (75 μm), or may be narrow, such as from about 20 mesh (850 μm) to about 40 mesh (425 μm).

The particle pack or bed may also be regenerated by removing the nanoparticles and coal fines, for example, using a lightly acidic water. In one nonrestrictive embodiment, the acidic water may be 1% HCl or 2% citric acid in tap water. The acidic water may flow through the sand pack, stripping the nanoparticle additives and the trapped/fixed coal fines. The sand pack may then be retreated with nanoparticles as described above. After removing the coal fines from the sand pack, the acidic water may be conditioned and/or disposed of. For example, sodium bicarbonate (NaHCO₃) may be added to the acidic water to neutralize it. The water may then be disposed of appropriately, depending on any contaminants in the coal fines.

It will be appreciated that it is not necessary for the method to remove all of the coal fines (100%) from an aqueous fluid for the method to be considered successful, although this is certainly a goal of the method. If a portion of the coal fines are removed, this is considered successful, but in one non-limiting embodiment at least 95% of the fines are removed; alternatively, at least 99% of the fines are removed.

The methods and compositions will now be illustrated with respect to a particular embodiment which is not intended to limit the invention in any way, but to more concretely illustrate it.

### Example

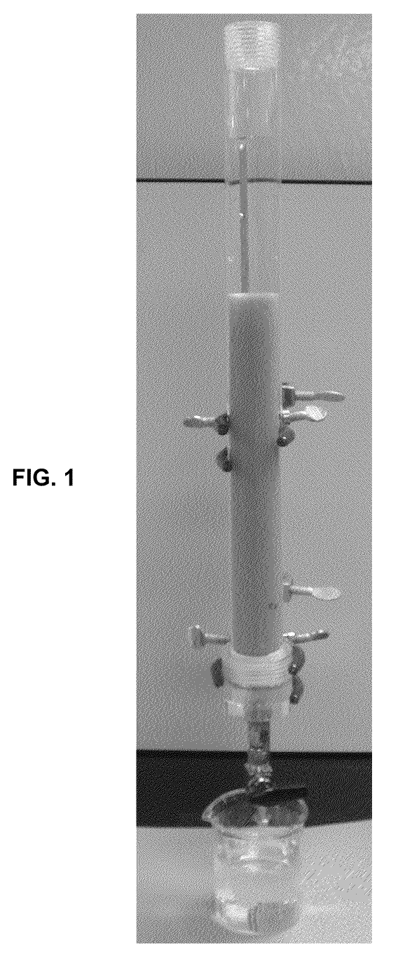

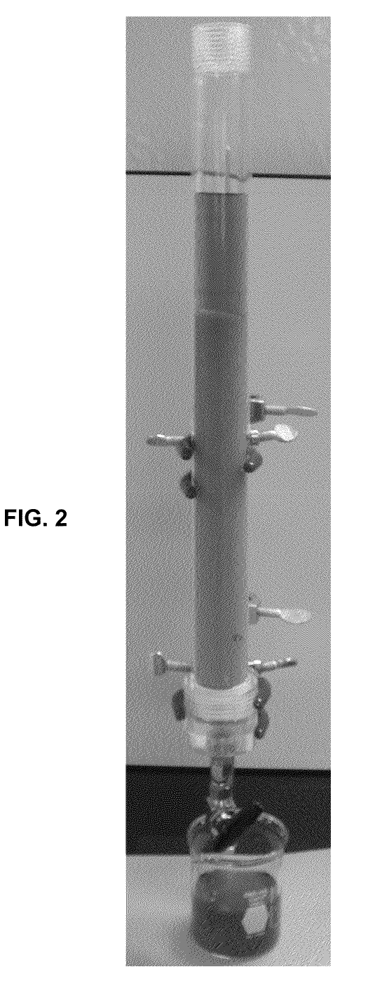

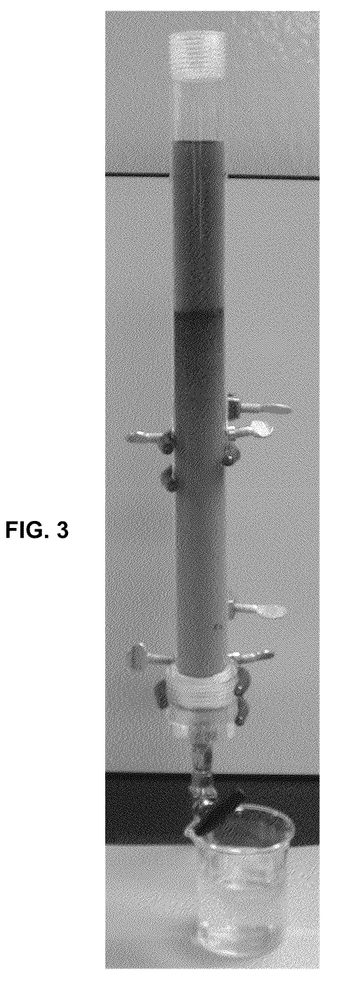

FIGS. 1-4 illustrate laboratory tests in which the removal of coal fines via sand packs is compared. In FIGS. 1-3, sand packs having a length of 12 inches (30 cm) and a diameter of 1 inch (2.54 cm) are shown. The sand packs have a particle range from about 20 mesh (850 μm) to about 40 mesh (425 μm). In FIGS. 1 and 2, the sand packs are not treated with nanoparticles; FIG. 3 shows a sand pack that has been treated with 0.1 vol % MgO nanocrystals.

FIG. 1 shows tap water containing no coal fines flowing through the above-described sand pack containing no nanoparticles. As expected, the effluent is clear.

FIG. 2 shows water containing coal fines flowing through the untreated sand pack. As can be seen, the effluent from the sand pack is a black fluid. The turbidity of the coal fine fluid before passing through the sand pack is 602 FAU (Formazin Attenuation Units) and after passing through the sand pack is 505 FAU. That is, 84 percent of coal fines are passed through the untreated sand pack.

FIG. 3 shows the water containing coal fines flowing through the nanoparticle-treated sand pack described above. The procedure for making the nanoparticle-treated sand pack shown in FIG. 3 is as follows:
1. Mix MgO nanocrystals having an average particle size of about 30 nm with 99.8 wt % monopropylene glycol (MPG) to make a 1 ppg (pound per gallon) nano-fluid suspension. That is, add 1 lb of MgO nanocrystals to 1 gal of MPG.
2. Add 3 mL of the nano-fluid from step 1 to 300 grams of 20/40 mesh sand in a bottle, and shake the bottle for several minutes to uniformly coat the sand in the nano-fluid.
3. Pour the nanoparticle-treated sand into an acrylic tube having a 1 in. inner diameter to form a 12 in. long sand pack.

The coal fine fluid may then be added to the top of the tube. In the present example, the turbidity of the water containing coal fines is 815 FAU before being added to the tube. Turbidity represents the suspended particle's concentration in solution. The effluent from the sand pack is a clear fluid having a turbidity of 21 FAU. That is, only 2.5 volume percent of coal fines are passed through the sand pack treated with 0.1 vol % nanoparticles.

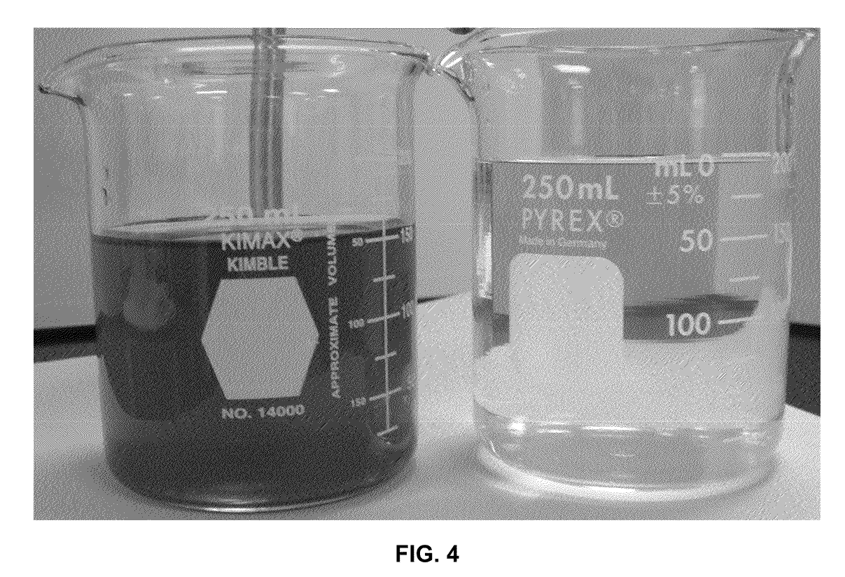

FIG. 4 is a side-by-side comparison of the effluent from the FIG. 2 photograph (left) and the effluent from the FIG. 3 photograph (right) showing the sharp contrast between the two effluents. The water in the left beaker is cloudy and black, whereas the water in the right beaker is clear and transparent.

### CONCLUSION

It will be evident that various modifications and changes may be made to the foregoing specification without departing from the broader spirit or scope of the invention as set forth in the appended claims. Accordingly, the specification is to be regarded in an illustrative rather than a restrictive sense. For example, specific combinations of alkaline earth metal oxides, alkaline earth metal hydroxides, transition metal oxides, transition metal hydroxides, post-transition metal oxides, post-transition metal hydroxides, piezoelectric crystals, and pyroelectric crystals falling within the claimed parameters, but not specifically identified or tried in a particular composition, are anticipated to be within the scope of this invention. Additionally, various substrates, coating agents, components, and methods not specifically described herein may still be encompassed by the following claims.

The words “comprising” and “comprises” as used throughout the claims is to be interpreted as “including but not limited to”. The present invention may suitably comprise, consist of, or consist essentially of the elements disclosed and may be practiced in the absence of an element not disclosed.

What is claimed is:

1. A method for removing coal fines from aqueous fluids, comprising contacting an aqueous fluid containing coal fines with a particle pack comprising substrate particles and nanoparticles, where the nanoparticles are selected from the group consisting of alkaline earth metal oxides, alkaline earth metal hydroxides, transition metal oxides, transition metal hydroxides, post-transition metal oxides, post-transition metal hydroxides, piezoelectric crystals, pyroelectric crystals, and mixtures thereof.

2. The method of claim 1, where the substrate particles are selected from the group consisting of sand, gravel, ceramic beads, glass beads, and combinations thereof.

3. The method of claim 1, where:
the alkaline earth metal is selected from the group consisting of magnesium, calcium, strontium, barium, and combinations thereof;
the transition metal is selected from the group consisting of titanium, zirconium, cobalt, nickel, zinc, and combinations thereof;
the post-transition metal is selected from the group consisting of aluminum, gallium, indium, tin, thallium, lead, bismuth, and combinations thereof; and
the piezoelectric crystals are selected from the group consisting of zinc oxide, berlinite, lithium tantalate, gallium orthophosphate, barium titanate, strontium titanate, lead zirconate titanate, potassium niobate, lithium niobate, lithium tantalate, bismuth ferrite, sodium tungstate, Ba₂NaNb₅O₅, Pb₂KNb₅O₁₅, potassium sodium tartrate, tourmaline, topaz, and combinations thereof.

4. The method of claim 1, where the nanoparticles have a mean particle size from about 4 nm to about 500 nm.

5. The method of claim 1, where the nanoparticles have a mean particle size of less than about 100 nm.

6. The method of claim 1, where the substrate particles range in size from about 10 mesh to about 325 mesh.

7. The method of claim 1, where the substrate particles range in size from about 20 mesh to about 40 mesh.

8. The method of claim 1, where the nanoparticles are present in an amount of about 1 part by weight for about 200 to about 5000 parts by weight of the particle pack.

9. The method of claim 1, where the nanoparticles are present in an amount of about 1 part by weight for about 1000 to about 2000 parts by weight of the particle pack.

10. The method of claim 1, further comprising stripping the coal fines from the particle pack using an acidic aqueous solution.

11. A particle pack for removing coal fines from an aqueous fluid, comprising:
a plurality of substrate particles selected from the group consisting of sand, gravel, ceramic beads, glass beads, and combinations thereof; and
nanoparticles, where the nanoparticles:
are selected from the group consisting of alkaline earth metal oxides, alkaline earth metal hydroxides, transition metal oxides, transition metal hydroxides, post-transition metal oxides, post-transition metal hydroxides, piezoelectric crystals, pyroelectric crystals, and mixtures thereof; and
are present in an amount effective to remove at least a portion of the coal fines from the aqueous fluid.

12. The particle pack of claim 11, where:
the alkaline earth metal is selected from the group consisting of magnesium, calcium, strontium, barium, and combinations thereof;
the transition metal is selected from the group consisting of titanium, zirconium, cobalt, nickel, zinc, and combinations thereof;
the post-transition metal is selected from the group consisting of aluminum, gallium, indium, tin, thallium, lead, bismuth, and combinations thereof; and
the piezoelectric crystals are selected from the group consisting of zinc oxide, berlinite, lithium tantalate, gallium orthophosphate, barium titanate, strontium titanate, lead zirconate titanate, potassium niobate, lithium niobate, lithium tantalate, bismuth ferrite, sodium tungstate, Ba₂NaNb₅O₅, Pb₂KNb₅O₁₅, potassium sodium tartrate, tourmaline, topaz, and combinations thereof.

13. The particle pack of claim 11, where the nanoparticle additives are present in an amount of about 1 part by weight for about 200 to about 5000 parts by weight of the particle pack.

14. The particle pack of claim 11, where the nanoparticles have a mean particle size from about 4 nm to about 500 nm.

15. The particle pack of claim 11, where the nanoparticles have a mean particle size less than about 100 nm.

16. A method for preparing a particle pack for removal of coal fines from an aqueous fluid, comprising:
adding nanoparticles to a carrier fluid to create a nano-fluid;
coating porous substrate particles with the nano-fluid; and
forming the substrate particles into a particle pack.

17. The method of claim 16, comprising adding the nano-fluid to a base fluid, where the base fluid comprises water, brine, an aqueous-based foam, a water-alcohol mixture, or a combination thereof.

18. The method of claim 16, where adding the nanoparticles to the carrier fluid comprises adding nanoparticles selected from the group consisting of alkaline earth metal oxides, alkaline earth metal hydroxides, transition metal oxides, transition metal hydroxides, post-transition metal oxides, post-transition metal hydroxides, piezoelectric crystals, pyroelectric crystals, and mixtures thereof to the carrier fluid.

19. The method of claim 16, where adding the nanoparticles to the carrier fluid comprises adding the nanoparticles to a water, a brine, an alcohol, a glycol, a polyol, an alkyl carbonate, an olefin, an organic solvent, a vegetable oil, a fish oil, a mineral oil, or a mixture thereof.

20. The method of claim 16, where coating the porous substrate particles with the nano-fluid comprises coating sand, gravel, ceramic beads, glass beads, or a combination thereof with the nano-fluid.
